(19) United States
(12) Patent Application Publication
(10) Pub. No.: US 2017/0367536 A1
(43) Pub. Date: Dec. 28, 2017

(54) STAINLESS STEEL FOOD SERVICE VESSELS

(71) Applicant: Marty Guy Wall, Greenbrier, TN (US)

(72) Inventor: Marty Guy Wall, Greenbrier, TN (US)

(21) Appl. No.: 15/586,454

(22) Filed: May 4, 2017

Related U.S. Application Data
(63) Continuation-in-part of application No. 29/601,915, filed on Apr. 27, 2017.
Application No. 29/601,915 is a continuation-in-part of application No. 29/588,018, filed on Dec. 16, 2016.
Application No. 29/588,018 is a continuation-in-part of application No. 29/588,010, filed on Dec. 16, 2016.
Application No. 29/588,010 is a continuation-in-part of application No. 29/588,006, filed on Dec. 16, 2016.
Application No. 29/588,006 is a continuation-in-part of application No. 29/588,001, filed on Dec. 16, 2016.
Application No. 29/588,001 is a continuation-in-part of application No. 29/587,988, filed on Dec. 16, 2016.
Application No. 29/587,988 is a continuation-in-part of application No. 29/585,144, filed on Nov. 21, 2016.
Application No. 29/585,144 is a continuation-in-part of application No. 29/584,129, filed on Nov. 11, 2016.
Application No. 29/584,129 is a continuation-in-part of application No. 29/574,920, filed on Aug. 19, 2016.
Application No. 29/574,920 is a continuation-in-part of application No. 29/573,043, filed on Aug. 2, 2016.
Application No. 29/573,043 is a continuation-in-part of application No. 29/568,915, filed on Jun. 22, 2016, now Pat. No. D789152.
Application No. 29/568,915 is a continuation-in-part of application No. 29/568,912, filed on Jun. 22, 2016.

(51) Int. Cl. A47J 41/02; A47G 23/02; A47G 19/22; B65D 81/38; A47J 41/00

(52) U.S. Cl. CPC A47J 41/028; B65D 81/3883; A47J 41/0055; A47J 41/0011; A47G 19/2255; A47G 23/0241; A47G 23/0233; A47G 2023/0283

(57) ABSTRACT

A stainless steel food service vessel is configured to provide an insulating carrier containing a food item or beverage. The stainless steel vessel is formed of a double wall construction having a sealed insulating cavity defined between the walls of the vessel. The insulating cavity may contain an insulating fluid or may be evacuated under a vacuum to impart superior insulating properties to the vessel to keep food items or beverages hot or cold.

### CROSS-REFERENCE TO RELATED APPLICATION

This application is a continuation in part application and claims the benefit of priority of the following U.S. design patent applications: 29/568,912, filed Jun. 22, 2016; 29/568,915, filed Jun. 22, 2016; 29/573,043, filed Aug. 2, 2016; 29/574,920, filed Aug. 19, 2016; 29/584,129, filed Nov. 11, 2016; 29/585,144, filed Nov. 21, 2016; 29/587,988, filed Dec. 16, 2016; 29/588,001, filed Dec. 16, 2016; 29/588,006, filed Dec. 16, 2016; 29/588,010, filed Dec. 16, 2016; 29/588,018, filed Dec. 16, 2016; and 29/601,915, filed Apr. 27, 2017; the contents of which are herein incorporated by reference.

### BACKGROUND OF THE INVENTION

The present invention relates to food service vessels and, more particularly, to vessels for containing and serving food items providing thermal insulation to the hot or cold food items carried therein.

### SUMMARY OF THE INVENTION

In one aspect of the present invention, a stainless steel food service vessel, includes a vessel body formed of stainless steel. The vessel body has a top opening and a dual wall construction formed by an interior wall and an exterior wall. The interior wall defines an internal cavity for containing a food item. An insulating cavity is defined in a void between the interior wall and the exterior wall, and the void is contained by a joining seal between the interior wall and the exterior wall. An annular rim is defined by a juncture of the interior wall and the exterior wall surrounding the top opening.

A lid may be received within the annular rim and is configured to seal around the annular rim to contain food items within the internal cavity. In some embodiments the lid includes a cylindrical constriction to be received within the annular rim. The cylindrical constriction is formed to have a diameter dimensioned to receive one of a beverage can or a beverage bottle. In other embodiments, the lid may be configured as a serving dish that is configured to be received within the annular rim of the top opening. In other embodiments, the lid is threadingly received within the top opening by a plurality of internal threads defined in the interior wall around a periphery of the top opening. Alternatively, a plurality of external threads are defined in the exterior wall around a periphery of the top opening.

Preferably, the exterior wall and the interior wall are substantially parallel throughout a majority of the vessel body. The insulating cavity may be filled with an insulating fluid. Alternatively, the void within the insulating cavity may comprise a vacuum.

These and other features, aspects and advantages of the present invention will become better understood with reference to the following drawings, description and claims.

### BRIEF DESCRIPTION OF THE DRAWINGS

FIG. 1 is a perspective view of a first embodiment of the food service vessel.

FIG. 2 is a side elevation view of the first embodiment of the food service vessel.

FIG. 3 is a bottom plan view of the first embodiment of the food service vessel.

FIG. 4 is a side cross sectional view of the first embodiment taken along line 4-4 of FIG. 3.

FIG. 5 is a perspective view of a can or bottle cooler embodiment of the food service vessel.

FIG. 6 is a top plan view of the can or bottle cooler embodiment of the food service vessel.

FIG. 7 is a bottom plan view of the can or bottle cooler embodiment of the food service vessel.

FIG. 8 is a side cross sectional view of the can or bottle cooler embodiment taken along line 8-8 of FIG. 7.

FIG. 9 is a perspective view of a serving dish embodiment of the food service vessel.

FIG. 10 is a bottom plan view of the serving dish embodiment of the food service vessel.

FIG. 11 is an exploded perspective view of the serving dish embodiment of the food service vessel.

FIG. 12 is a side cross sectional view of the serving dish embodiment of the food service vessel taken along line 12-12 of FIG. 10.

FIG. 13 is a side elevation view of a liquid containment bottle embodiment of the food service vessel.

FIG. 14 is a bottom plan view of the liquid containment bottle of the food service vessel.

FIG. 15 is a side cross sectional view of the liquid containment bottle taken along line 15-15 of FIG. 14.

FIG. 16 is a top plan view of the liquid containment bottle.

FIG. 17 is a detail sectional view of an external thread liquid containment bottle lid.

FIG. 18 is a side cross sectional view of an embodiment of a stemmed drinking vessel.

FIG. 19 is a perspective view of the embodiment of the stemmed drinking vessel.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved food service vessel for containing food items, such as liquid beverages, sauces, dips, yogurt, ice cream, and the like. The food service vessel is formed of a double walled stainless steel construction to insulate the food items carried by the vessel.

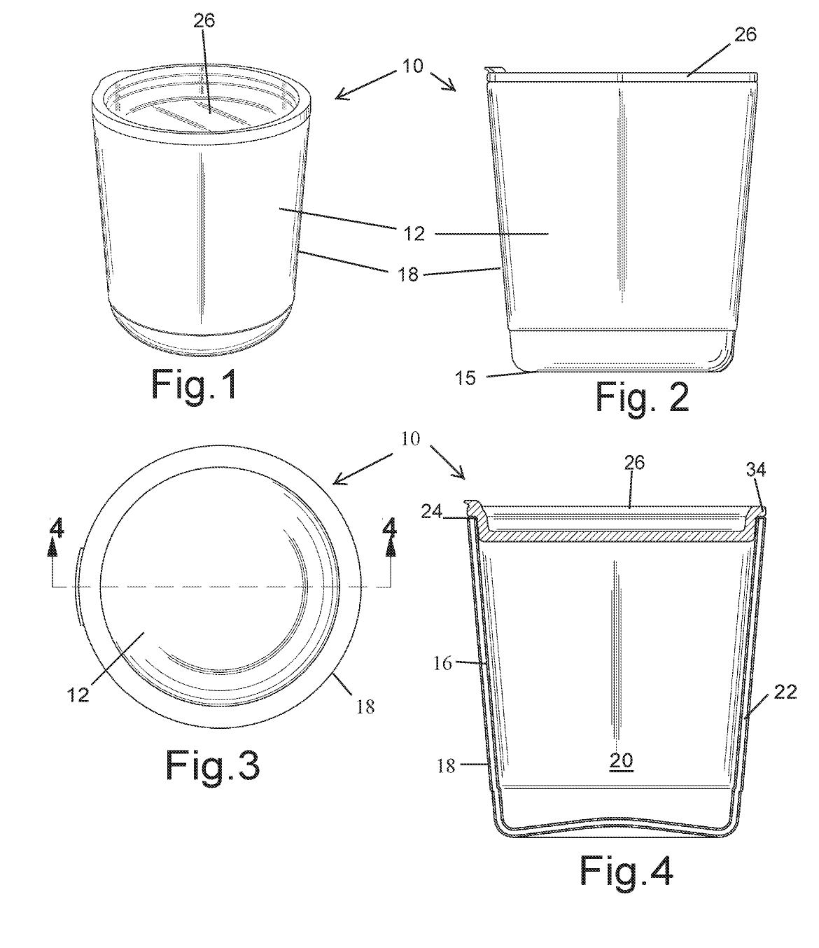

As seen in reference to the drawings of FIGS. 1-17, the stainless steel food service vessel 10 includes a vessel body 12 formed of stainless steel. The vessel body 12 has a top opening 14 and a dual wall construction formed by an interior wall 16 and an exterior wall 18. The interior wall 16 defines an internal cavity 20 for containing a food item. The vessel body 12 may also have a base, or bottom 15, which may be configured with an interior portion that extends inwardly towards the internal cavity 20.

The vessel body may 12 may be formed in a variety of shapes and styles such that the interior wall 16 and the exterior wall 18 are defined substantially parallel to each other throughout the shape of the vessel body 12. By way of non-limiting example, the body may be configured as a bottle, a glass, a dish, a holder for another food service vessel, such as a beverage can or bottle. The vessel body 12 may also include a carrying or holding handle extending from the exterior wall 18. In other embodiments, the vessel body 12 may include a stem support 17 extending from the base 15.

An insulating cavity 22 is defined by a void between the interior wall 16 and the exterior wall 18. The void is contained by a joining seal between the interior wall 16 and the exterior wall 18. An annular rim 24 is defined by a juncture of the interior wall 16 and the exterior wall 18 that surrounds the top opening 14. The joining seal may be defined around the annular rim 24 or around the base 15.

A lid 26 may be received within the annular rim 24. The lid 26 is configured to seal around or within the annular rim 24 to contain food items within the internal cavity 20 without leakage. The lid 26 may be configured for an interference fit for frictional engagement with the annular rim 24 and or the interior wall 16 proximal to the top opening 14.

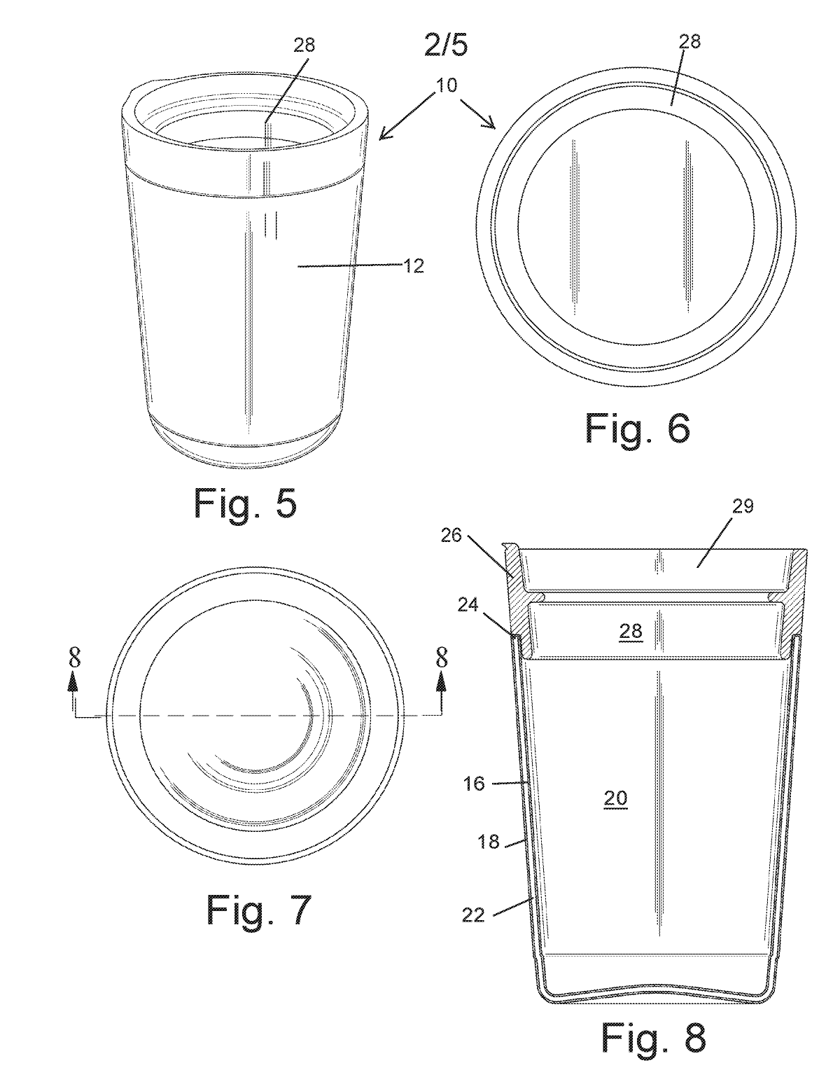

As seen in reference to FIGS. 5-8, in some embodiments the food service vessel 10 is configured as a can or bottle carrier. In this case, the lid 26 may include at least one cylindrical constriction 28 having a top opening 29 and an interior opening 30 formed therein. The cylindrical constriction 28 has a diameter dimensioned to receive one of a beverage can or a beverage bottle. The internal cavity 20 is also dimensioned to receive the beverage can or bottle therein.

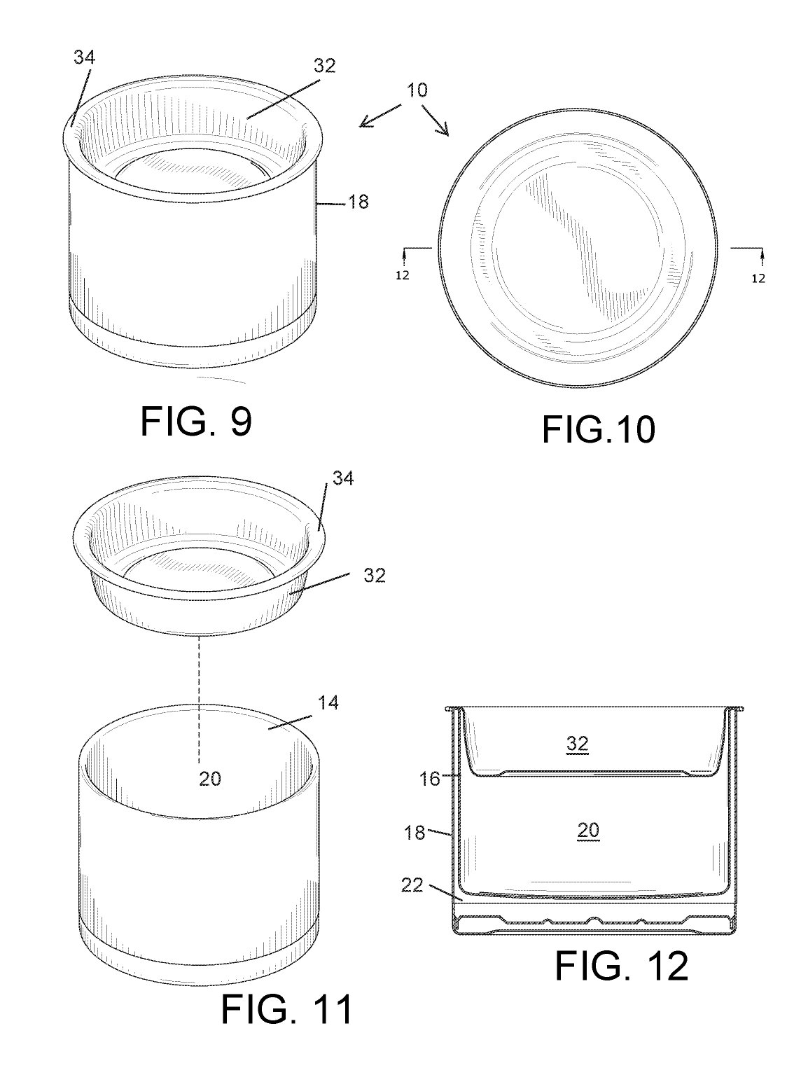

As seen in reference to the drawings of FIGS. 9-12, the lid 26 may be configured as a serving dish 32. The serving dish 32 has an annular lip 34 that is dimensioned to be supported by the annular rim 24. The serving dish 32 may be utilized to serve food items such as dips, sauces, ice cream and the like. In this case the internal cavity 20 may be filled with chilled water and/or ice to keep the food item chilled, while the double wall construction of the vessel body 12 provides insulation for the ice. Alternatively, the internal cavity 20 may be filled with hot water or the like to keep the food item carried in the dish 32 warm.

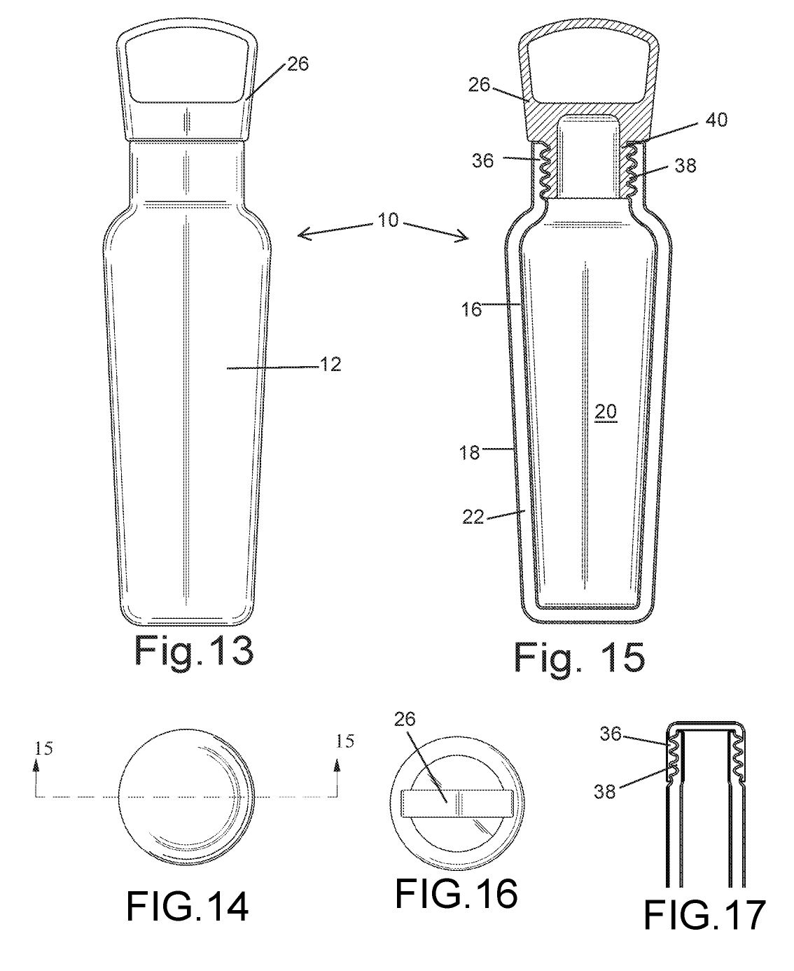

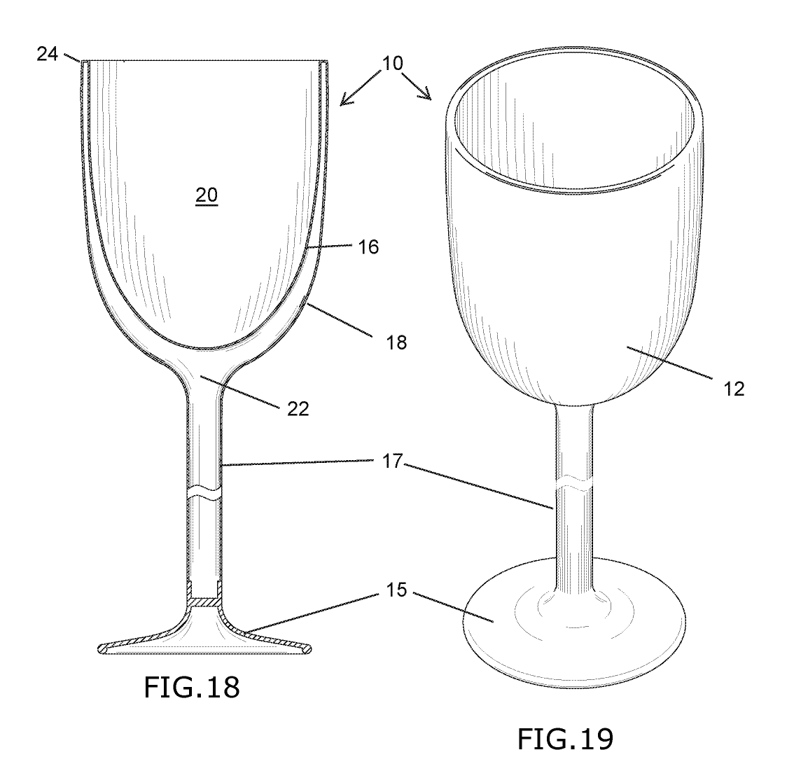

In yet other embodiments of the food service vessel, such as shown in reference to FIGS. 13-17, the lid 26 may be configured to be threadingly received within the top opening 14. The interior wall 16 may be configured with a plurality of internal threads 36, while the lid 26 may be provided with a threaded extension 40 having a plurality of external threads 38. Alternatively, as seen in reference to FIG. 17, the lid 26 may have a plurality of internal threads 36, while the outer wall 18 is provided with a plurality of external threads. These embodiments are preferred for containing a larger volume of liquids and beverages for pouring into a glass or mug.

The exterior wall 18 and the interior wall 16 may be defined in a wide variety of profiles such that they are substantially parallel throughout a majority of the vessel body 10. The superior insulating properties of stainless steel are improved with an insulating cavity 20, which may be filled with an insulating fluid. Alternatively, the void within the insulating cavity 20 may be evacuated under a vacuum before the interior wall 16 and the exterior wall 18 are sealingly joined, such as by a weld, to one another.

It should be understood, of course, that the foregoing relates to exemplary embodiments of the invention and that modifications may be made without departing from the spirit and scope of the invention as set forth in the following claims.

What is claimed is:

1. A stainless steel food service vessel, comprising:
a vessel body formed of stainless steel, the vessel body having a top opening, the vessel body having a dual wall construction formed by an interior wall and an exterior wall, the interior wall defining an internal cavity for containing a food item;
an insulating cavity defined in a void between the interior wall and the exterior wall, the void contained by a joining seal between the interior wall and the exterior wall; and
an annular rim defined by a juncture of the interior wall and the exterior wall, the annular rim surrounding the top opening.

2. The stainless steel food service vessel of claim 1, further comprising:
a lid received within the annular rim, wherein the lid is configured to seal around the annular rim to contain food items within the internal cavity.

3. The stainless steel food service vessel of claim 1, further comprising:
a cylindrical constriction forming the annular rim, the cylindrical constriction having a diameter dimensioned to receive one of a beverage can or a beverage bottle.

4. The stainless steel food service vessel of claim 1, further comprising:
a serving dish configured to be received within the annular rim of the top opening.

5. The stainless steel food service vessel of claim 2, wherein the lid is threadingly received within the top opening.

6. The stainless steel food service vessel of claim 5, further comprising:
a plurality of internal threads defined in the interior wall around a periphery of the top opening.

7. The stainless steel food service vessel of claim 5, further comprising:
a plurality of external threads defined in the exterior wall around a periphery of the top opening.

8. The stainless steel food service vessel of claim 1, wherein the exterior wall and the interior wall are substantially parallel throughout a majority of the vessel body.

9. The stainless steel food service vessel of claim 1, wherein the insulating cavity is filled with an insulating fluid.

10. The stainless steel food service vessel of claim 9, wherein the void within the insulating cavity comprises a vacuum.

11. The stainless steel food service vessel of claim 1, further comprising:
a base; and
a stem interconnecting the base with a bottom of the vessel body.
